(19) United States
(12) Patent Application Publication
(10) Pub. No.: US 2015/0143492 A1
(43) Pub. Date: May 21, 2015

(54) SYSTEM AND METHOD FOR IDENTIFYING COLLABORATORS ON A SHARED MOBILE DEVICE

(71) Applicant: International Business Machines Corporation, Armonk, NY (US)

(72) Inventors: Christopher J. Berry, Cammeray (AU); Philip S.P. Chan, Marrickville (AU); Laurence A. Hey, Manly (AU)

(73) Assignee: International Business Machines Corporation, Armonk, NY (US)

(21) Appl. No.: 14/083,729

(22) Filed: Nov. 19, 2013

(51) Int. Cl. H04L 29/06

(52) U.S. Cl. CPC H04L 63/0861
USPC 726/7

(57) ABSTRACT

A method, computer program product, and system is provided for identifying collaborators on a shared mobile device. In an implementation, a method may include receiving, by a shared mobile device, an identifier input including one or more biometric identifiers associated with a user. The method may also include receiving, by the shared mobile device, a collaborative content input from the user, the collaborative content input being associated with at least a portion of collaborative content. The method may further include comparing the one or more biometric identifiers associated with the user with biometric identifiers of a plurality of users of the shared mobile device. The method may further include, when the identifier input including the one or more biometric identifiers associated with the user matches a biometric identifier of an identified user of the plurality of users of the shared mobile device, associating the identified user with the collaborative content input.

### TECHNICAL FIELD

The present disclosure generally relates to identifying users of a mobile device, and more particularly relates to systems and methods for identifying collaborators on a shared mobile device.

### BACKGROUND

Many individuals often carry a mobile device. Mobile devices may often be used by individuals to engage in, or at least allow for the possibility, of communicating with others, even when an individual is not at a fixed location, such as a home or office. Examples of mobile devices may include, but are not limited to, cellular telephones, smartphones, tablet computing devices, notebook or laptop computers, or the like. Such mobile devices may allow individuals to engage in and/or receive a variety of communications from others. Mobile devices may also be used to access content, such as documents, presentations, drawings, and the like. Mobile devices may also be shared between a group of individuals and to access the content. For example, a group of individuals may use a shared mobile device to collaborate on the content.

### SUMMARY OF DISCLOSURE

According to an implementation, a method may include receiving, by a shared mobile device, an identifier input including one or more biometric identifiers associated with a user. The method may also include receiving, by the shared mobile device, a collaborative content input from the user, the collaborative content input being associated with at least a portion of collaborative content. The method may further include comparing the one or more biometric identifiers associated with the user with biometric identifiers of a plurality of users of the shared mobile device. The method may further include, when the identifier input including the one or more biometric identifiers associated with the user matches a biometric identifier of an identified user of the plurality of users of the shared mobile device, associating the identified user with the collaborative content input.

One or more of the following features may be included. The received one or more biometric identifiers may include at least one of facial recognition, fingerprint recognition, iris and/or retina recognition, and voice recognition

The method may also include, when the identifier input including the one or more biometric identifiers associated with the user does not match a biometric identifier of one of the plurality of users of the shared mobile device, prompting the user for identification details.

The method may also include setting the identified user as a current user of the shared mobile device.

The method may further include editing the portion of the collaborative content based upon, at least in part, the received collaborative content input.

The method may include providing an indicator of the associated identified user and the collaborative content input within the collaborative content. The collaborative content may include one or more collaborative content inputs from at least a portion of the plurality of users of the shared mobile device.

According to another implementation, a computer program product may include a non-transitory computer readable medium having a plurality of instructions stored on it. When executed by a processor, the instructions may cause the processor to perform operations including receiving, by a shared mobile device, an identifier input including one or more biometric identifiers associated with a user. Instructions may also be included for receiving a collaborative content input from the user, the collaborative content input being associated with at least a portion of collaborative content. Instructions may also be included for comparing the one or more biometric identifiers associated with the user with biometric identifiers of a plurality of users of the shared mobile device. Instructions may also be included for, when the identifier input including the one or more biometric identifiers associated with the user matches a biometric identifier of an identified user of the plurality of users of the shared mobile device, associating the identified user with the collaborative content input.

One or more of the following features may be included. The received one or more biometric identifiers may include at least one of facial recognition, fingerprint recognition, iris and/or retina recognition, and voice recognition.

Instructions may be included for, when the identifier input including the one or more biometric identifiers associated with the user does not match a biometric identifier of one of the plurality of users of the shared mobile device, prompting the user for identification details.

Instructions may also be included for setting the identified user as a current user of the shared mobile device.

Instructions may also be included for editing the portion of the collaborative content based upon, at least in part, the received collaborative content input.

Instructions may also be included for providing an indicator of the associated identified user and the collaborative content input within the collaborative content. The collaborative content may include one or more collaborative content inputs from at least a portion of the plurality of users of the shared mobile device.

According to yet another implementation, a system may include at least one processor device and at least one memory architecture coupled with the at least one processor device. The at least one processor device may be configured for receiving, by a shared mobile device, an identifier input including one or more biometric identifiers associated with a user. The at least one processor may also be configured for receiving a collaborative content input from the user, the collaborative content input being associated with at least a portion of collaborative content. The at least one processor may further be configured for comparing the one or more biometric identifiers associated with the user with biometric identifiers of a plurality of users of the shared mobile device. The at least one processor may further be configured for, when the identifier input including the one or more biometric identifiers associated with the user matches a biometric identifier of an identified user of the plurality of users of the shared mobile device, associating the identified user with the collaborative content input.

One or more of the following features may be included. The received one or more biometric identifiers may include at least one of facial recognition, fingerprint recognition, iris and/or retina recognition, and voice recognition.

The at least one processor may be further configured for, when the identifier input including the one or more biometric identifiers associated with the user does not match a biometric identifier of one of the plurality of users of the shared mobile device, prompting the user for identification details.

The at least one processor may be further configured for setting the identified user as a current user of the shared mobile device.

The at least one processor may be further configured for editing the portion of the collaborative content based upon, at least in part, the received collaborative content input.

The at least one processor may be further configured for providing an indicator of the associated identified user and the collaborative content input within the collaborative content.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an identification process according to an implementation of the present disclosure;

FIG. 2 is a flowchart of the identification process of FIG. 1, according to an implementation of the present disclosure;

FIG. 3 is a diagrammatic view of the computing device of FIG. 1, according to an implementation of the present disclosure.

Like reference symbols in the various drawings indicate like elements.

### DETAILED DESCRIPTION

Many individuals often carry a mobile device. Mobile devices may often be used by individuals to engage in, or at least allow for the possibility, of communicating with others, even when an individual is not at a fixed location, such as a home or office. Examples of mobile devices may include, but are not limited to, cellular telephones, smartphones, tablet computing devices, notebook or laptop computers, or the like. In some situations, mobile devices may also be shared between a group of individuals and to create and/or access content, such as documents, presentations, drawings, and the like. For example, a group of individuals may use a shared mobile device to collaborate on the content, or otherwise engage in a collaborative activity that may include or relate to the content.

According to some embodiments, the present disclosure may allow for identification of users associated with at least one shared mobile device. For example, a shared mobile device may be passed to different users. The present disclosure may allow for identification of each user based upon, at least in part, unique characteristics of each user. For example, unique characteristics of the user may include, but are not limited to, biometric identifiers such as facial recognition, voice recognition, iris and/or retina recognition, fingerprint recognition, and the like. For example, a user may be identified as a result of normal use of the shared mobile device, such as simply by holding the shared mobile device in front of the user's face while reviewing the collaborative content, which may allow the shared mobile device to capture a photo of the user's face. In this manner, an identifying characteristic of the user may be captured, for example, in a generally passive way without having to manually enter identification details, such as a username or password. Other biometric identifiers may be captured in similar manners, e.g., as by recording the users' voice, capturing a fingerprint by an appropriate detector, etc. The user may be identified, for example, by comparing the captured biometric identifier to known (e.g., previously captured) biometric identifiers of one or more individuals. In an embodiment, the identified user may provide a collaborative content input associated with at least a portion of the collaborative content. The collaborative content input may be associated with the identified user, such that a history of collaborative content inputs, including comments, edits, contributions, and the like, may be automatically stored and accessed as needed. Further, in some embodiments, by associating the collaborative content input with the identified user, the source of the collaborative content input may be known.

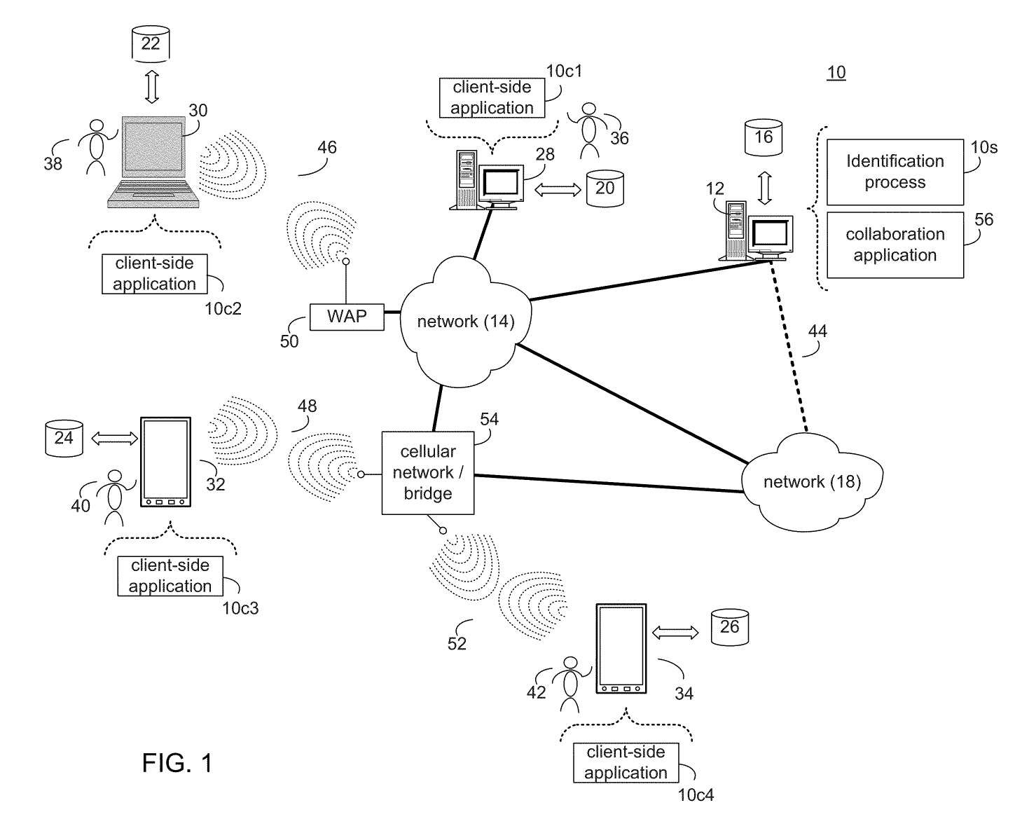

Referring to FIG. 1, there is shown identification process 10. For the following discussion, it is intended to be understood that identification process 10 may be implemented in a variety of ways. For example, identification process 10 may be implemented as a server-side process, a client-side process, or a server-side/client-side process.

For example, identification process 10 may be implemented as a purely server-side process via identification process 10s. Alternatively, identification process 10 may be implemented as a purely client-side process via one or more of client-side application 10c1, client-side application 10c2, client-side application 10c3, and client-side application 10c4. Alternatively still, identification process 10 may be implemented as a server-side/client-side process via identification process 10s in combination with one or more of client-side application 10c1, client-side application 10c2, client-side application 10c3, and client-side application 10c4. In such an example, at least a portion of the functionality of identification process 10 may be performed by identification process 10s and at least a portion of the functionality of identification process 10 may be performed by one or more of client-side application 10c1, 10c2, 10c3, and 10c4.

Accordingly, identification process 10 as used in this disclosure may include any combination of identification process 10s, client-side application 10c1, client-side application 10c2, client-side application 10c3, and client-side application 10c4.

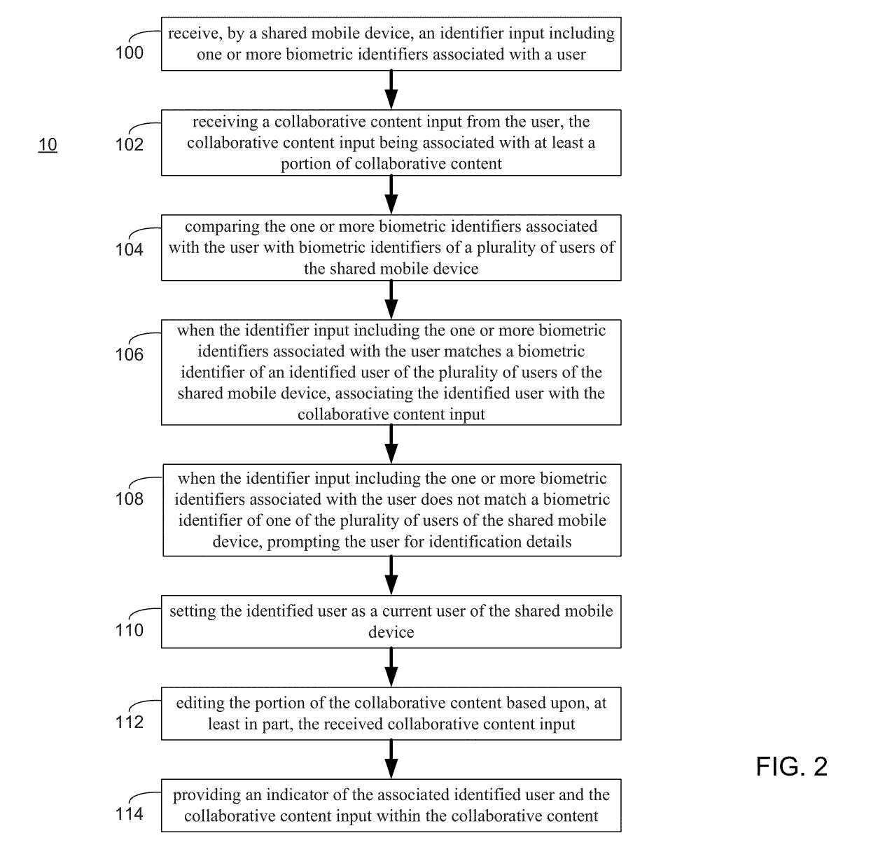

Referring also to FIG. 2, and as will be discussed in greater detail below, in an embodiment, identification process 10 may receive 100, by a shared mobile device, an identifier input including one or more biometric identifiers associated with a user. Identification process 10 may also receive 102, by the shared mobile device, a collaborative content input from the user, the collaborative content input being associated with at least a portion of collaborative content. Identification process 10 may further compare 104 the one or more biometric identifiers associated with the user with biometric identifiers of a plurality of users of the shared mobile device. Identification process 10 may further, when the identifier input including the one or more biometric identifiers associated with the user matches a biometric identifier of an identified user of the plurality of users of the shared mobile device, associate 106 the identified user with the collaborative content input.

Identification process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a dedicated network device.

The instruction sets and subroutines of identification process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c1, 10c2, 10c3, 10c4 may include an application or process for implementing features and/or operations of identification process 10. For example, client-side applications 10c1, 10c2, 10c3, 10c4 may include and/or interact with an operating system of a mobile device. Additionally, in some embodiments client-side applications 10c1, 10c2, 10c3, 10c4 may include, but are not limited to, client-side collaboration applications. Examples of such client-side collaboration applications may include, but are not limited to, a word processing application, a presentation application, an electronic spreadsheet application, a drawing application, a web browser (e.g., which may interact and/or communicate with other resources and/or applications) and/or any specialized application that may include collaborative content that may be created and/or modified by a plurality of users (e.g., an application running on a mobile platform). Additionally/alternatively, identification process 10 may interact and/or communicate with one or more collaboration applications. The instruction sets and subroutines of client-side application 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, personal computer 28, laptop computer 30, mobile computing device 32, tablet computing device 34, a netbook computer (not shown), a server computer (not shown), a gaming console (not shown), a data-enabled television console (not shown), and a dedicated network device (not shown). Client electronic devices 28, 30, 32, 34 may each execute an operating system.

Users 36, 38, 40, 42 may access identification process 10 directly on respective client electronic devices 28, 30, 32, 34, and/or through network 14 or through secondary network 18. Further, identification process 10 may be accessed through secondary network 18 via link line 44.

The various client electronic devices (e.g., client electronic devices 28, 30, 32, 34) may be directly or indirectly coupled to network 14 (or network 18). For example, personal computer 28 is shown directly coupled to network 14. Further, laptop computer 30 is shown wirelessly coupled to network 14 via wireless communication channel 46 established between laptop computer 30 and wireless access point (WAP) 50. Similarly, mobile computing device 32 is shown wirelessly coupled to network 14 via wireless communication channel 48 established between mobile computing device 32 and cellular network/bridge 54, which is shown directly coupled to network 14 and network 18. WAP 50 may be, for example, an IEEE 802.11a, 802.11b, 802.11g, 802.11n, Wi-Fi, Bluetooth, and/or ANT device that is capable of establishing wireless communication channel 46 between laptop computer 30 and WAP 50. Additionally, tablet computing device 34 is shown wirelessly coupled to network 14 via wireless communication channel 52 established between tablet computing device 34 and cellular network/bridge 54, which is shown directly coupled to network 14 and network 18.

In some embodiments, identification process 10 may communicate with, interact with, and/or include a component or module of a collaboration application (e.g., collaboration application 56). As is generally known, a collaboration application (e.g., collaboration application 56) may generally facilitate collaboration between multiple parties. For example, collaboration application 56 may facilitate collaboration of content between a plurality of users. In some embodiments, collaboration application may include, and/or may interact with, for example, a word processing application, a presentation application, an electronic spreadsheet application, a drawing application, a social networking application, and/or any specialized application that may include collaborative content that may be created and/or modified by a plurality of users (e.g., an application running on a mobile platform).

In an embodiment, the instruction sets and subroutines of collaboration application 56 may be stored, e.g., on storage device 16 associated with server computer 12, which executes collaboration application 56, and/or another suitable storage device. Further, users (e.g., one or more of users 36, 38, 40, 42) may access collaboration application 56 in order to participate in a collaboration session. The users may access collaboration application 56 via one or more suitable applications, such as client side applications 10c1-10c4 (e.g., which may include a word processing application, a presentation application, an electronic spreadsheet application, a drawing application, and/or any specialized application that may include collaborative content that may be created and/or modified by a plurality of users) and/or via a different application (not shown). As generally discussed above, a portion and/or all of the functionality of identification process 10 may be provided by one or more of client side applications 10c1-10c4. For example, in some embodiments identification process 10 (and/or client-side functionality of identification process 10) may be included within and/or interactive with client-side applications 10c1-10c4, which may include client side collaboration applications, web browsers, or another application. Various additional/alternative configurations may be equally utilized.

As generally discussed above with reference to FIG. 2, in an embodiment identification process 10 may receive 100, by a shared mobile device, an identifier input including one or more biometric identifiers associated with a user. Identification process 10 may also receive 102, by the shared mobile device, a collaborative content input from the user, the collaborative content input being associated with at least a portion of collaborative content. Identification process 10 may further compare 104 the one or more biometric identifiers associated with the user with biometric identifiers of a plurality of users of the shared mobile device. Identification process 10 may further, when the identifier input including the one or more biometric identifiers associated with the user matches a biometric identifier of an identified user of the plurality of users of the shared mobile device, associate 106 the identified user with the collaborative content input.

For the purpose of the following description, tablet computing device 34 may be described. However the description of tablet computing device 34 is intended for the purpose of illustration only. In various embodiments, the shared mobile device may include another mobile device, such as a smart phone device, a notebook computer, and/or any other mobile computing device.

In an embodiment identification process 10 may receive 100, by a shared mobile device, an identifier input including one or more biometric identifiers associated with a user. For example, tablet computing device 34 may be a shared mobile device, such that a plurality of users may use a common tablet computing device 34. The plurality of users may pass tablet computing device 34 to different users, thus allowing the plurality of users to access and collaborate on content (e.g., via client-side application 10c4, which may include a collaboration application, and/or via collaboration application 56, which may be accessed via tablet computing device 34) using shared mobile device (e.g., tablet computing device 34).

In general, biometrics may refer to the identification of individuals by their characteristics and traits. Biometric identifiers may include distinct, measurable characteristics which may be used to identify an individual. As such, some biometric identifiers of individuals may be unique to each individual. Examples of biometric identifiers may include, but are not limited to, facial recognition, fingerprint recognition, iris and/or retina recognition, and voice recognition. As discussed above, identification process 10 may receive 100, by a shared mobile device, an identifier input including one or more biometric identifiers associated with a user. For example, user 42 may utilize shared mobile device (e.g., tablet computing device 34). Tablet computing device 34 may include functionality to detect one or more biometric identifiers, including, but not limited to, a camera (not shown), microphone (not shown), fingerprint scanner (not shown), iris scanner (not shown), and/or any other feature having functionality capable of allowing identification process 10 to detect and/or capture a biometric identifier of a user.

For example, identification process 10 may receive 100 an identifier input including one or more biometric identifiers associated with user 42 having tablet computing device 34. Further, identification process 10 may receive 100 an identifier input including one or more biometric identifiers associated with user 42 having tablet computing device 34. In an embodiment, identification process 10 may not prompt user 42 to manually enter or input identification details of user 42 prior to logging in to, or otherwise using, tablet computing device 34. Identification process 10 may receive 100 one or more biometric identifiers from user 42 including at least one of facial recognition, fingerprint recognition, iris and/or retina recognition, and voice recognition. For example, while using tablet computing device 34, user 42 may hold tablet computing device 34 in such a manner that a camera (not shown) of tablet computing device 34 may capture a photo of user 42's face. Similarly, while using table computing device 34, user 42 may speak into a microphone (not shown) of tablet computing device 34, allowing identification process 10 to capture a sample of user 42's voice. Further still, user 42 may hold tablet computing device 34 in such a manner that fingerprint scanner (not shown) of tablet computing device 34 may scan and read user 42's fingerprint. Tablet computing device 34 may also include an iris scanner (not shown) that may scan user 42's iris. Thus, identification process 10 may receive 100 an identifier input including one or more biometric identifiers associated with user 42, e.g., while user 42 is using tablet computing device 34. Various additional and/or alternative biometric identifiers (whether based upon physical features and/or behavioral characteristics) may similarly be received 100 by identification process 10 via various suitable input means and/or sensors.

Identification process 10 may also receive 102 a collaborative content input from the user, the collaborative content input being associated with at least a portion of collaborative content. Collaborative content may include any content that may be created and/or modified by a user, or a plurality of users, of the shared mobile device, and/or one or more additional devices. Examples of collaborative content may include, but are not limited to, a word processing document, a presentation, a drawing document, and/or any other content that may be created and/or edited by a plurality of users (e.g., either simultaneously and/or at different points in time). Referring to the previous example, user 42 may provide a collaborative content input (such as a command or spoken content that may be converted to text via speech-to-text functionality, etc.) as a spoken input associated with at least a portion of collaborative content, which may be received 102, for example, via a microphone (not shown) of tablet computing device 34. For example, user 42 may wish to modify at least a portion of a presentation that user 42's team has been collaborating on using tablet computing device 34. User 42 may speak the command to apply (e.g., utilizing speech input, or speech-to-text capabilities) to a portion of the presentation into the microphone (not shown) of tablet computing device 34. Thus, identification process 10 may receive 102 the command as a collaborative content input associated with at least a portion of the presentation from user 42. Alternatively, identification process 10 may receive 102 the collaborative content input by any means available, including, but not limited to, a manually entered text input, or the like.

Identification process 10 may further compare 104 the one or more biometric identifiers associated with the user with biometric identifiers of a plurality of users of the shared mobile device. Identification information associated with a plurality of users, including the one or more biometric identifiers associated with the plurality of users, may be stored within a data store. Accordingly, in some embodiments, identification process 10 may access a data store, and may compare 104 the one or more biometric identifiers associated with the user with biometric identifiers of a plurality of users based on, at least in part, the identification information of the plurality of users within the data store. In various implementations, the data store may be maintained on the shared mobile device (e.g., storage device 26 of tablet computing device 34 in the foregoing example) via which the one or more biometric identifiers is received, and/or may be maintained on another device (e.g., storage device 16 associated with computing device 12, and or on another storage device associated with another computing device).

Examples of a data store may include, but are not limited to, a list, a database, a directory, a corporate directory (such as an LDAP directory), and/or any type of collection of data. Identification information associated with a user stored within the data store may include, but is not limited to, a name of the user, contact information for the user, such as phone number, email, and/or the like, and any other identifying information of the user. One or more biometric identifiers associated with the user may also be stored within the data store, such as an image of the user's face, an audio recording of the user's voice, a scan of the user's iris and/or retina, and/or a scanned fingerprint of the user. Various other biometric identifiers may also and/or alternatively be stored within the data store. As generally set forth in the above example, a biometric identifier associated with the plurality of users may include the same and/or a similar biometric identifier as biometric identifier included within the identifier input that may be received 100 by identification process 10.

Comparing 104 the one or more biometric identifiers associated with the user with biometric identifiers of a plurality of users based on, at least in part, the identification information of the plurality of users within the data store may include executing a query on the data store for user identification information correlated to the identifier input, including the one or more biometric identifiers, received 100 by the shared mobile device (e.g., tablet computing device 34). Continuing with the above example, when user 42 (operating tablet computing device 34) speaks a collaborative content input (such as a command or spoken content to be converted to text via speech-to-text functionality) associated with at least a portion of the collaborative content into a microphone (not shown) of tablet computing device 34, identification process 10 may receive 100, by tablet computing device 34, the speech from user 42. In such an example, the biometric identifier received 100 by identification process 10 may include voice characteristics associated with user 42, e.g., which may be quantified and/or characterized using voice recognition functionality. Identification process 10 (alone and/or in conjunction with one or more other applications or processes) may execute a query on the data store based on the received 100 one or more biometric identifiers associated with user 42 (e.g., the spoken command). As such, identification process 10 may compare 104 the one or more biometric identifiers (e.g., voice characteristics) associated with user 42 with biometric identifiers of a plurality of users based on, at least in part, the identification information of the plurality of users within the data store. That is, identification process 10 may compare the received 100 voice characteristics to saved voice characteristics associated with other users, which may be stored in the data store. In some embodiments, the queried population (e.g., the plurality of users against which the received 100 identifier input is compared) may include all users for whom appropriate biometric identifier information (e.g., speech characteristics in the foregoing illustrative example) is available. In some embodiments, the queried population may be constrained based on one or more criteria. For example, the plurality of users of the shared mobile device may be known based upon, e.g., a common calendar/scheduling item indicating that they are currently working together on the collaborative content, known proximity of the users of the shared mobile device (e.g., based upon other wireless devices, access controlled facility, etc.), the users being logged into an application (such as collaboration application), etc.

Identification process 10 may further, when the identifier input including the one or more biometric identifiers associated with the user matches a biometric identifier of an identified user of the plurality of users of the shared mobile device, associate 106 the identified user with the collaborative content input. As described above, identification process 10 may compare 104 (e.g., based on a query executed on the data store, or other suitable mechanism) the one or more biometric identifiers associated with the user with biometric identifiers of a plurality of users based on, at least in part, the identification information of the plurality of users within the data store. Based upon the comparison, identification process 10 may determine whether a match exists between the received 100 identifier input, including the one or more biometric identifiers associated with the user, and biometric identifiers of a plurality of users stored within the data store. If a match exists, identification process 10 may determine an identity of the user based upon the identification information stored in data store associated with the identified user. That is, for example, in response to determining a match between the biometric identifier of the received 100 identifier input and the stored biometric identifiers of one of the plurality of users, identification process 10 may determine that the user from whom the identifier input was received is the individual of the plurality of users who is associated with the matching biometric identifier from the data store.

In an embodiment, identification process 10 may prompt the user for verification as the identified user. For example, identification process may display the identity of the user on a screen of the shared mobile device and prompt the identified user to select “yes” or “no” to confirm identification of the user. In some embodiments, identification process 10 may display the identity of the user on the screen of the shared mobile device. If the user determines that the displayed identity is not correct, the user may indicate an erroneous identity determination. If the user determines that the displayed identity is correct, the user may take no action in that regard. That is, a confirmation that the displayed identity is correct may not be required. Upon identification of the user, identification process 10 may associate 106 the identified user with the received 102 collaborative content input. In the above-example, the received 102 collaborative content input may include a spoken command and/or a manually entered text input. Identification process 10 may associate 106 the identified user with the received 102 collaborative content. In an embodiment, associating 106 the identified user with the collaborative content input may further include identification process 10 automatically storing the association 106 within the data store. In this manner, a history of collaborative content inputs and respective authors/contributors may be stored and accessed at a later time.

In an embodiment, identification process 10 may, when the identifier input including the one or more biometric identifiers associated with the user does not match a biometric identifier of one of the plurality of users of the shared mobile device, prompt 108 the user for identification details. As described above, identification process 10 may compare 104 (e.g., based on a query executed on the data store, or other suitable mechanism) the one or more biometric identifiers associated with the user with biometric identifiers of a plurality of users based on, at least in part, the identification information of the plurality of users within the data store. Based upon the comparison, identification process 10 may determine whether a match exists between the received 100 identifier input, including the one or more biometric identifiers associated with the user, and biometric identifiers of a plurality of users stored within the data store. In an embodiment, if a match does not exist, identification process 10 display a list of likely users based upon, at least in part, the query executed on the data store. The list may be sorted by likelihood of the match. The user may select a user from the list of likely users. In some embodiments, identification process 10 may further prompt the user for a password to verify the user.

In an embodiment, if a match does not exist, identification process 10 may prompt 108 the user for identification details. Identification process may prompt 108 the user for identification details including a name of the user, contact information for the user, such as phone number, email, and/or the like, one or more biometric identifiers associated with the user including at least one of an image of the user's face, an audio recording of the user's voice, a scan of the user's iris and/or retina, and/or a scanned fingerprint of the user, and/or any other identification information associated with the user. Identification process 10 may receive the identification details of the user, including the one or more biometric identifiers of the user (e.g., an image of the user's face via a camera of the shared mobile device, an audio recording of the user's voice via a microphone of the shared mobile device, a scan of the user's iris and/or retinal via an occular scanner of the shared mobile device, and/or a scanned fingerprint of the user via a fingerprint scanner of the shared mobile device). Identification process 10 may store the identification details of the user to the data store.

In an example embodiment, user 42 may use the shared mobile device (e.g., tablet computing device 34) to access collaborative content. Identification process 10 may automatically receive 100 an identifier input, including one or more biometric identifiers associated with user 42, via tablet computing device 34 (e.g., an image of user 42's face via a camera of tablet computing device 34, a spoken command of user 42 via a microphone of tablet computing device 34, or other biometric identifier associated with user 42). Identification process 10 may compare 104 the received 100 one or more biometric identifiers associated with user 42 with biometric identifiers of a plurality of users of tablet computing device 34 (e.g., based on a query executed on the data store, or other suitable mechanism). If identification process 10 matches the received 100 one or more biometric identifiers with a biometric identifier of the plurality of users of tablet computing device 34, identification process 10 may identify user 42. If identification process 10 does not match the received 100 one or more biometric identifiers with a biometric identifier of the plurality of users of tablet computing device 34, identification process 10 may not identify user 42. Upon identification process 10 not identifying user 42 as an identified user of tablet computing device 34, identification process 10 may prompt 106 user 42 for identification details. Identification process 10 may receive the identification details associated with user 42, including, but not limited to, user 42's name, contact information, a password, and one or more biometric identifiers, including at least one of an image of user 42's face (via a camera of tablet computing device 34), a scanned fingerprint of user 42 (via a fingerprint scanner of tablet computing device 34), a scanned iris and/or retina of user 42 (via an iris scanner of tablet computing device 34), and an audio recording of user 42's voice (via a microphone of tablet computing device 34). Identification process 10 may store the identification details associated with user 42 in the data store. Upon receiving and storing the identification details associated with user 42, identification process 10 may identify user 42 as the user of tablet computing device 34. Identification process 10 may then associate 106 identified user 42 with the received 102 collaborative content input received from user 42. Identification process 10 may further store the association 106 to the data store.

In an embodiment, identification process 10 may set 110 the identified user as a current user of the shared mobile device. Further, identification process 10 may display an identification of the identified user as the current user of the shared mobile device. For example, identification process 10 may identify user 42 as the user of tablet computing device 34 based upon, at least in part, the identifier input, including the one or more biometric identifiers associated with user 42, received 100 from user 42. Identification process 10 may display user 42's name as the current user of tablet computing device 34 on the screen of tablet computing device 34.

In a further embodiment, identification process 10 may edit 112 the portion of the collaborative content based upon, at least in part, the received collaborative content input. As discussed above, identification process 10 may receive 102 a collaborative content input from the user, the collaborative content input being associated with at least a portion of collaborative content. Collaborative content may include any content that may be created and/or modified by one or more users. Examples of collaborative content may include, but are not limited to, a word processing document, a presentation, and/or a drawing document. Based upon the received 102 collaborative content input associated with at least a portion of collaborative content from the user, identification process 10 may edit 112 the portion of the collaborative content. For example, user 42 may provide the collaborative content input associated with at least a portion of the collaborative content (e.g., word document, presentation, drawing document, or any other collaborative content). As described above, user 42 may provide the collaborative content input by speaking a command to apply to at least a portion of the collaborative content. Identification process 10 may use speech-to-text technology to apply the spoken command to the portion of the collaborative content (e.g., to perform some action on the portion of the collaborative content and/or to create, add to, or modify the portion of the collaborative content. Alternatively, user 42 may manually enter textual edits to the portion of the collaborative content. In this manner, based upon the received 102 collaborative content input from user 42, identification process 10 may edit 112 at least a portion of collaborative content. That is, user 42 may add, delete, modify, and/or comment on portions of the collaborative content.

In an embodiment, identification process 10 may provide 114 an indicator of the associated identified user and the collaborative content input within the collaborative content. Identification process 10 may display the identification of the user who provided the collaborative content input associated with the portion of collaborative content as a visual indicator. For example, continuing with the above-described example, identification process 10 may display the identity of user 42 as the user that edited 112 the portion of the collaborative content. In this manner, as at least a portion of the plurality of users of shared mobile device (e.g., tablet computing device 34) provide one or more collaborative content inputs, identification process 10 may associate 106 each identified user with their respective collaborative content input(s). As user 42 reviews the collaborative content, identification process 10 may provide 114 a visual indicator identifying each user that provided the collaborative content input associated with each edit and/or modification made to the corresponding portion of collaborative content. For example, if user 42 provides a collaborative content input associated with a portion of a presentation, the portion of the presentation may be edited 112. Identification process 10 may provide 114 a visual indicator near the portion of the presentation that has been edited 112, indicating that user 42 has modified that portion of the presentation. The visual indicator may include the identity of user 42, along with a time and date stamp, and/or any other information relating to the modification made to the portion of the presentation.

As briefly discussed above, collaborative content may include one or more collaborative content inputs from at least a portion of the plurality of users of the shared mobile device. Continuing with the above example, user 42 may no longer require access to the collaborative content via shared mobile device (e.g., tablet computing device 34). User 42 may log out of tablet computing device 34, may put tablet computing device 34 away, and/or may hand tablet computing device 34 to another user (e.g., user 40). User 40 may access the collaborative content via tablet computing device 34 in a similar manner as described above. For example, without prompting user 40 for identification information, identification process 10 may automatically receive 100 an identifier input, including one or more biometric identifiers associated with user 40, via tablet computing device 34 (e.g., an image of user 40's face via a camera of tablet computing device 34, a spoken command of user 40 via a microphone of tablet computing device 34, or other biometric identifier associated with user 40). For example, user 40 may simply hold tablet computing device 34 in such a position while reviewing the collaborative content that identification process 10 may automatically receive 100 an image of user 40's face captured by tablet computing device 34. Alternatively, user 40 may simply speak while holding tablet computing device 34 such that identification process 10 may receive 100 the speech. Identification process 10 may compare 104 the received 100 one or more biometric identifiers (e.g., a captured image of user 40's face and/or user 40's voice) associated with user 40 with biometric identifiers of a plurality of users of tablet computing device 34 (e.g., based on a query executed on the data store, or other suitable mechanism). If identification process 10 matches the received 100 one or more biometric identifiers with a biometric identifier of the plurality of users of tablet computing device 34, identification process 10 may identify user 40. If identification process 10 does not match the received 100 one or more biometric identifiers with a biometric identifier of the plurality of users of tablet computing device 34, identification process 10 may not identify user 40. Upon identification process 10 not identifying user 40 as an identified user of tablet computing device 34, identification process 10 may prompt 106 user 40 for identification details. Identification process may set 110 user 40 as the current user of tablet computing device 34. Upon identification process 10 receiving 102 a collaborative content input from user 40 associated with at least a portion of collaborative content, identification process 10 may edit 112 the portion of the collaborative content based upon, at least in part, the received 102 collaborative content input from user 40. Identification process may further provide 114 a visual indicator of the collaborative content input received by user 40 and applied to the portion of collaborative content. In this manner, shared mobile device (e.g., tablet computing device 34) may be accessed by a plurality of users and identification process 10 may receive 100 an identifier input including one or more biometric identifiers associated with each of the plurality of users without disrupting the flow of collaboration on the shared mobile device by the plurality of users providing one or more collaborative content inputs associated with portions of the collaborative content. The one or more collaborative content inputs received from at least a portion of the plurality of users of the shared mobile device may be stored within a data store such that the collaborative content inputs are associated with the respective users who provided the collaborative content inputs. In this manner, identification process 10 may automatically store a history of collaborative content inputs without requiring manually identification of each user who provided each collaborative content input associated with portions of the collaborative content.

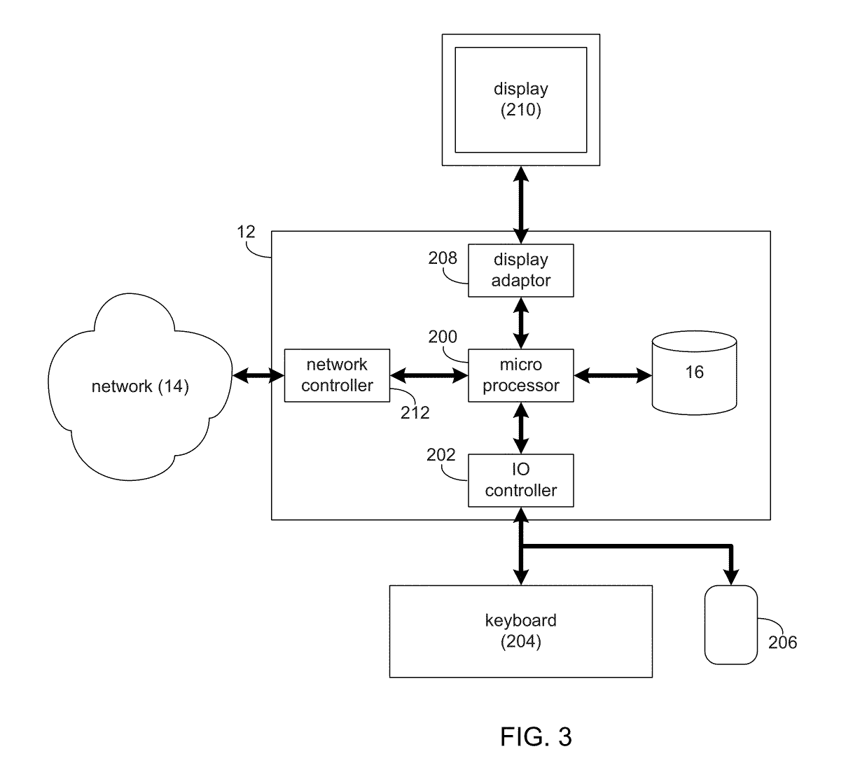

Referring also to FIG. 3, there is shown a diagrammatic view of computing system 12. While computing system 12 is shown in this figure, this is for illustrative purposes only and is not intended to be a limitation of this disclosure, as other configurations are possible. For example, any computing device capable of executing, in whole or in part, identification process 10 may be substituted for computing device 12 within FIG. 3, examples of which may include but are not limited to client electronic devices 28, 30, 32, 34.

Computing system 12 may include microprocessor 200 configured to e.g., process data and execute instructions/code for identification process 10. Microprocessor 200 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 202 may be configured to couple microprocessor 200 with various devices, such as keyboard 204, mouse 206, USB ports (not shown), and printer ports (not shown). Display adaptor 208 may be configured to couple display 210 (e.g., a CRT or LCD monitor) with microprocessor 200, while network adapter 212 (e.g., an Ethernet adapter) may be configured to couple microprocessor 200 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, C#.NET, PHP, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 200) of a general purpose computer/special purpose computer/other programmable data processing apparatus (e.g., computing device 12), such that the instructions, which execute via the processor (e.g., processor 200) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1.-7. (canceled)

8. A computer program product comprising a non-transitory computer readable medium having a plurality of instructions stored thereon, which, when executed by a processor, cause the processor to perform operations including:
receiving, by a shared mobile device, an identifier input including one or more biometric identifiers associated with a user;
receiving a collaborative content input from the user, the collaborative content input being associated with at least a portion of collaborative content;
comparing the one or more biometric identifiers associated with the user with biometric identifiers of a plurality of users of the shared mobile device; and
when the identifier input including the one or more biometric identifiers associated with the user matches a biometric identifier of an identified user of the plurality of users of the shared mobile device, associating the identified user with the collaborative content input.

9. The computer program product of claim 8, wherein the received one or more biometric identifiers include at least one of facial recognition, fingerprint recognition, iris and/or retina recognition, and voice recognition.

10. The computer program product of claim 8, further including instructions for:
when the identifier input including the one or more biometric identifiers associated with the user does not match a biometric identifier of one of the plurality of users of the shared mobile device, prompting the user for identification details.

11. The computer program product of claim 8, further including instructions for:
setting the identified user as a current user of the shared mobile device.

12. The computer program product of claim 8, further including instructions for:
editing the portion of the collaborative content based upon, at least in part, the received collaborative content input.

13. The computer program product of claim 8, further including instructions for:
providing an indicator of the associated identified user and the collaborative content input within the collaborative content.

14. The computer program product of claim 8, wherein the collaborative content includes one or more collaborative content inputs from at least a portion of the plurality of users of the shared mobile device.

15. A system comprising:
at least one processor device and at least one memory architecture coupled with the at least one processor device, the at least one processor device configured for:
receiving, by a shared mobile device, an identifier input including one or more biometric identifiers associated with a user;
receiving a collaborative content input from the user, the collaborative content input being associated with at least a portion of collaborative content;
comparing the one or more biometric identifiers associated with the user with biometric identifiers of a plurality of users of the shared mobile device; and
when the identifier input including the one or more biometric identifiers associated with the user matches a biometric identifier of an identified user of the plurality of users of the shared mobile device, associating the identified user with the collaborative content input.

16. The system of claim 15, wherein the received one or more biometric identifiers include at least one of facial recognition, fingerprint recognition, iris and/or retina recognition, and voice recognition.

17. The system of claim 15, the at least one processor further configured for:
when the identifier input including the one or more biometric identifiers associated with the user does not match a biometric identifier of one of the plurality of users of the shared mobile device, prompting the user for identification details.

18. The system of claim 15, the at least one processor further configured for:
setting the identified user as a current user of the shared mobile device.

19. The system of claim 15, the at least one processor further configured for:
editing the portion of the collaborative content based upon, at least in part, the received collaborative content input.

20. The system of claim 15, the at least one processor further configured for:
providing an indicator of the associated identified user and the collaborative content input within the collaborative content.
